(19) United States
(12) Patent Application Publication
(10) Pub. No.: US 2023/0224357 A1
(43) Pub. Date: Jul. 13, 2023

(54) OPTIMIZED ON-DEMAND FILE DOWNLOAD

(71) Applicant: Citrix Systems, Inc., Fort Lauderdale, FL (US)

(72) Inventors: Ke Xu, Nanjing (CN); Jia Yin, Nanjing (CN); Jessica Li, Nanjing (CN); Jie Zhuang, Nanjing (CN)

(21) Appl. No.: 17/578,605

(22) Filed: Jan. 19, 2022

Related U.S. Application Data
(63) Continuation of application No. PCT/CN2022/070690, filed on Jan. 7, 2022.

(51) Int. Cl. H04L 67/06; H04L 67/01; H04L 67/5683; H04L 67/306

(52) U.S. Cl. CPC H04L 67/06; H04L 67/42; H04L 67/2857; H04L 67/306

(57) ABSTRACT

In one disclosed method, a computing system receives a first request to download a first file to a client device. The computing system further sends, based at least in part on the first request, a first digest of the first file to the client device to enable the client device to compare the first digest with at least a second digest of a second file stored locally at the client device. The computing system further receives, after sending the first digest to the client device, a second request to refrain from downloading the first file to the client device.

### CROSS-REFERENCE TO RELATED APPLICATIONS

This application is a continuation of and claims the benefit under 35 U.S.C. § 120 and 35 U.S.C. § 365(c) to International Application PCT/CN2022/070690, entitled OPTIMIZED ON-DEMAND FILE DOWNLOAD, with an international filing date of Jan. 7, 2022, the entire contents of which are incorporated herein by reference for all purposes.

### BACKGROUND

Various file sharing systems have been developed that allow users to share files or other data. ShareFile®, offered by Citrix Systems, Inc., of Fort Lauderdale, Fla., is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a computing system, a first request to download a first file to a client device; sending, by the computing system and based at least in part on the first request, a first digest of the first file to the client device to enable the client device to compare the first digest with at least a second digest of a second file stored locally at the client device; and receiving, by the computing system after sending the first digest to the client device, a second request to refrain from downloading the first file to the client device.

In some embodiments, a method involves determining, by a client device, that downloading of a first file from a computing system to the client device has been requested; receiving, by the client device and from the computing system, a first digest of the first file; determining, by the client device, that the first digest matches at least a second digest of a second file stored locally at the client device; and outputting, by the client device and based at least in part on the first digest matching the second digest, an indication that at least a portion of the first file is stored locally at the client device.

In some embodiments, a system includes at least one processor and at least one computer-readable medium encoded with instructions which, when executed by the at least one processor, cause the system to receive a first request to download a first file to a client device; send, based at least in part on the first request, a first digest of the first file to the client device to enable the client device to compare the first digest with at least a second digest of a second file stored locally at the client device; and receive, after sending the first digest to the client device, a second request to refrain from downloading the first file to the client device.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a high-level diagram illustrating a computing system responding to a request to download a file to a client device, with duplicate detection, in accordance with some embodiments of the present disclosure;

FIG. 1B is a high-level diagram illustrating a client device orchestrating duplicate detection of a file requested for the client device, in accordance with some embodiments of the present disclosure;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A shows a first portion of an example process for a file download, with duplicate detection, that involves a file download request sent from a web-based file management application to an access management system of a file sharing system, in accordance with some embodiments;

FIG. 6B shows a second portion of the example process partially shown in FIG. 6A;

FIG. 6C shows a third portion of the example process partially shown in FIG. 6A;

FIG. 7A shows a first portion of an example process for a file download, with duplicate detection, that involves a file download request sent from a local file management application to an access management system of a file sharing system 504, in accordance with some embodiments;

FIG. 7B shows a second portion of the example process partially shown in FIG. 7A;

FIG. 7C shows a third portion of the example process partially shown in FIG. 7A;

FIG. 8A shows a first portion of an example process for a file download, with duplicate detection, that involves a file transfer request sent from a client device to a storage system of a file sharing system, in accordance with some embodiments;

FIG. 8B shows a second portion of the example process partially shown in FIG. 8A; and

FIG. 8C shows a third portion of the example process partially shown in FIG. 8A.

### DETAILED DESCRIPTION

For purposes of reading the description of the various embodiments below, the following descriptions of the sections of the specification and their respective contents may be helpful:

Section A provides an introduction to example embodiments of a file download system with duplicate detection;

Section B describes a network environment which may be useful for practicing embodiments described herein;

Section C describes a computing system which may be useful for practicing embodiments described herein.

Section D describes embodiments of systems and methods for delivering shared resources using a cloud computing environment;

Section E describes example embodiments of systems for providing file sharing over networks;

Section F provides a more detailed description of example embodiments of the file download system with duplicate detection introduced in Section A; and

Section G describes example implementations of methods, systems/devices, and computer-readable media in accordance with the present disclosure.

A. Introduction to Illustrative Embodiments of a File Download System with Duplicate Detection

Customary computer usage, whether for work, school, or personal purposes, may include downloading files to the local storage of the computer. This may include interfacing with a system designed for storing and sharing files, such as ShareFile®, offered by Citrix Systems, Inc., of Fort Lauderdale, Fla. Over time, a user may purposely or inadvertently download the same file on multiple occasions. For the user and the local computer, this may result in unnecessary time expended, especially for large files, as well as occupying unnecessary storage space, possibly resulting in an unorganized file structure. For the file server, this may incur repeated unnecessary bandwidth usage that may be taxing on the server, such as when the server may be handling large or high priority task loads.

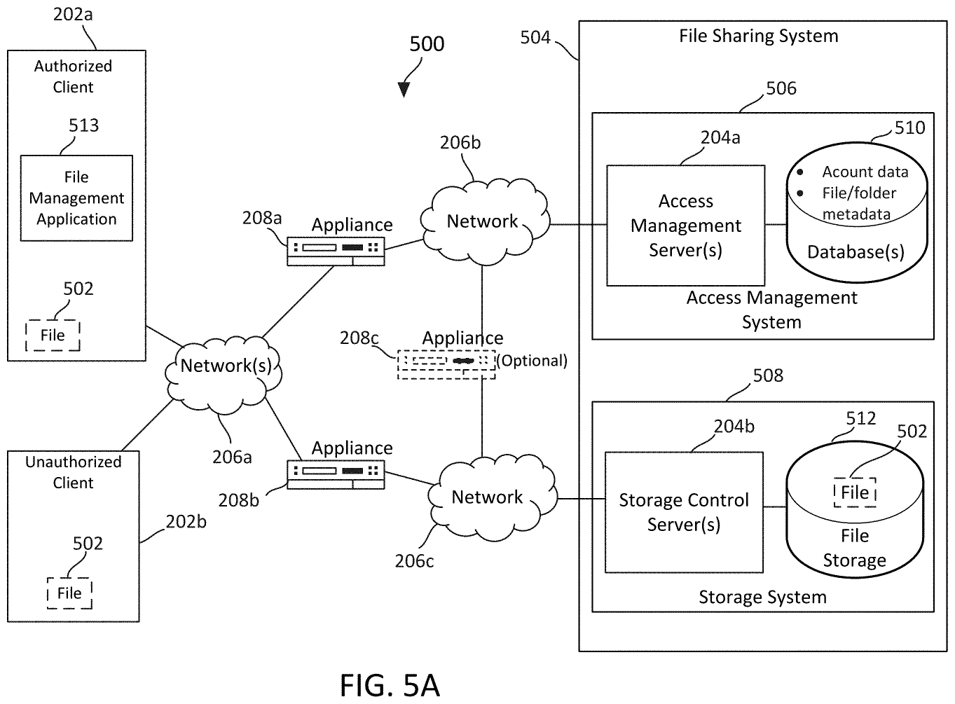

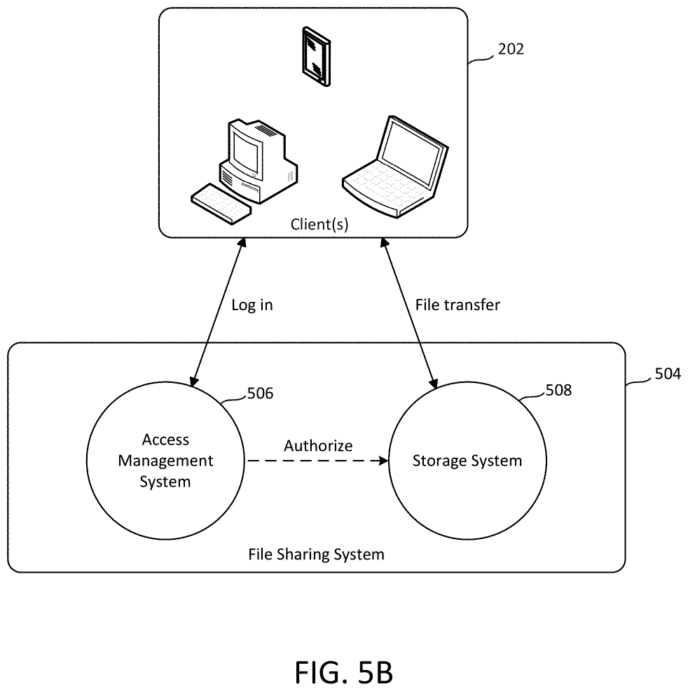

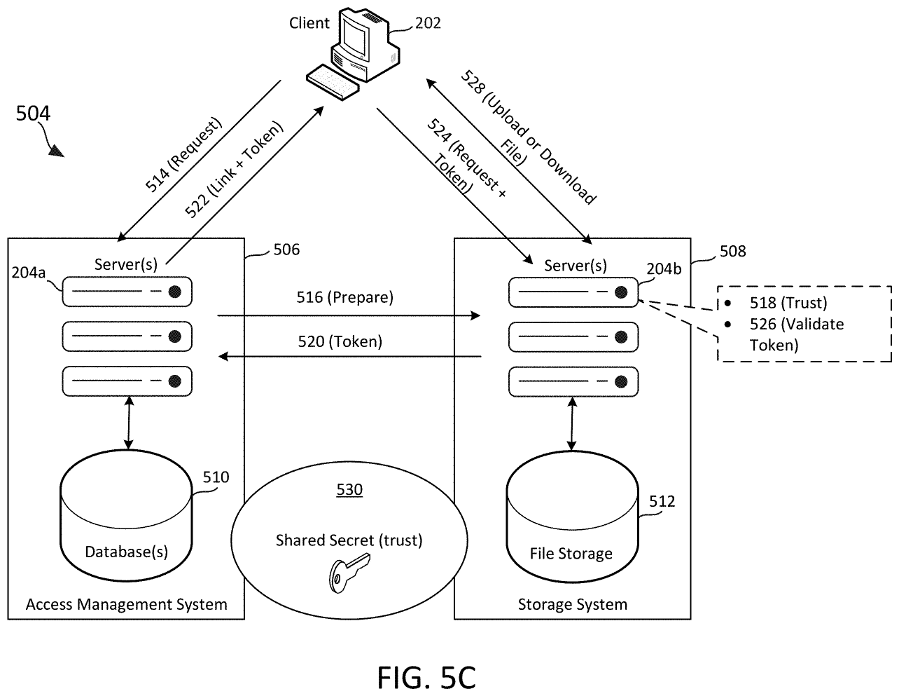

Various file sharing systems have been developed that allow users to share files with other users over a network. An example of such a file sharing system 504 is described below (in Section E) in connection with FIGS. 5A-C. As explained in Section E, in some implementations, one client device 202 may upload a file 502 (shown in FIG. 5A) to a central repository of the file sharing system 504, such as the storage medium(s) 512 shown in FIGS. 5A-C, and another client device 202 may then download a copy of that file 502 from the same repository. As Section E also describes, in some implementations, an access management system 506 may regulate the circumstances in which files 502 may be uploaded and/or downloaded to/from a storage system 508 (including the storage medium 512(s)) by various client devices 202.

Offered are systems and techniques for a client device 202 to request a download of a file, such as from a file sharing system 504, and for a client application of the client device 202 to perform duplicate detection for the file (compared to one or more files presently stored on the client device 202), where such duplicate detection occurs before a copy of the requested file is transferred to the client device 202. In some implementations, file digests may be generated for both the requested file and the files presently stored on the client device 202. The duplicate detection may be based on the comparison of the file digest for the requested file and the one or more file digests associated with the one or more files presently stored on the client device 202. In some implementations, one or more segment digests may be generated for a file by dividing the file into segments and then generating respective digests for the different segments. Comparing the segment digests associated with individual files may assist in identifying files which are similar, although not exactly the same. Comparing file digests and/or segment digests before the transferring a requested file may result in benefits such as reduced bandwidth and processing for an unnecessary file transfer.

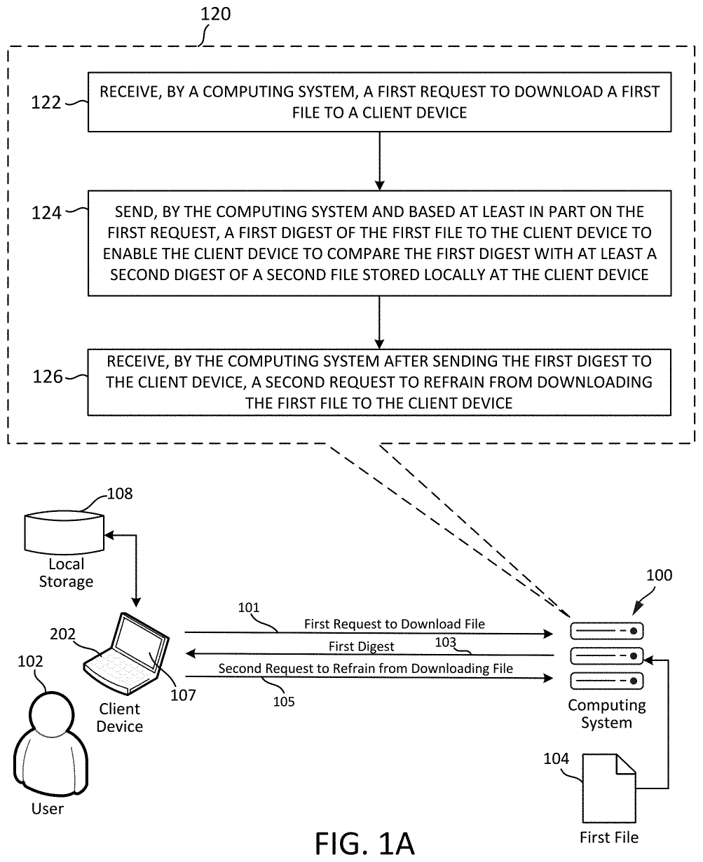

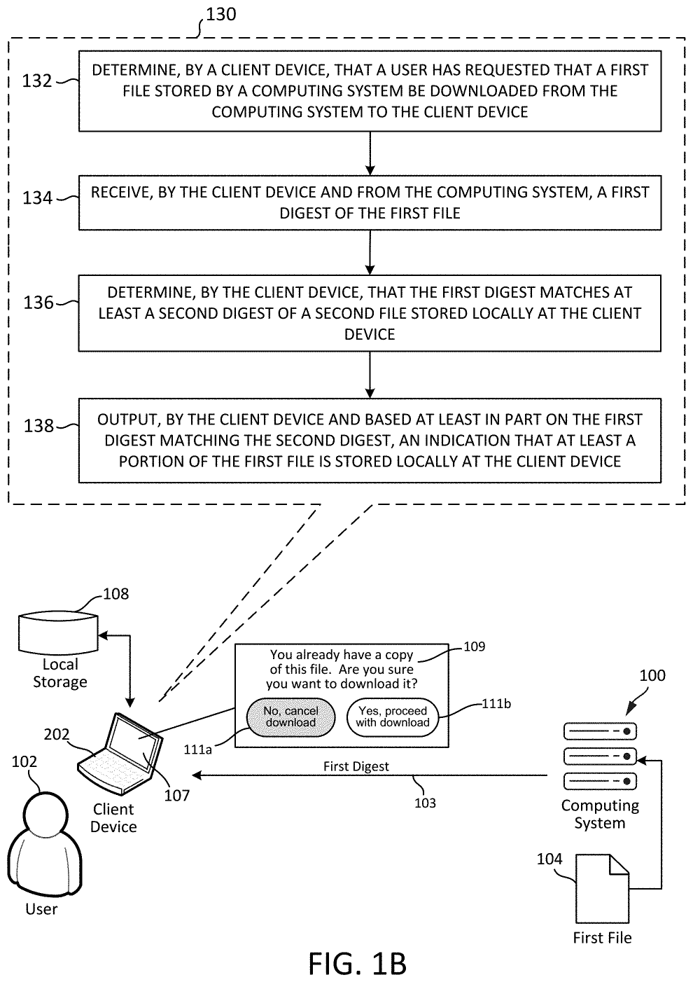

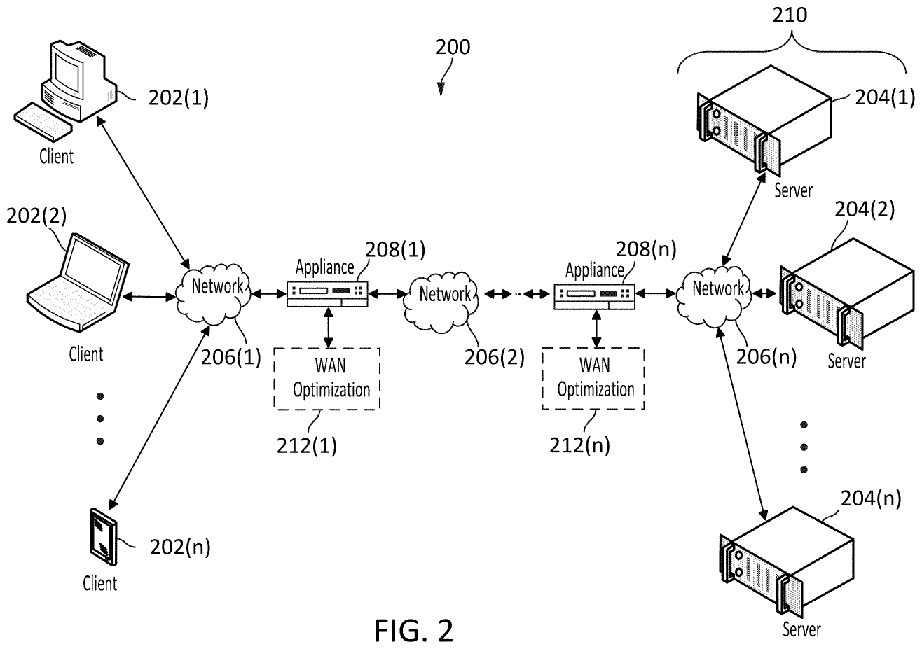

FIG. 1A is a high-level diagram illustrating a computing system 100 responding to a request, from a client device 202, for a first file 104 in a manner that allows for pre-transfer duplicate detection by the client device 202, in accordance with some aspects of the present disclosure. In some embodiments, the computing system 100 may be part of the file sharing system 504. In other embodiments, the file sharing system 504 may be in communication with the computing system 100. In some embodiments, the computing system 100 may include one or more servers 204 (examples of which are described below in relation to FIG. 2). For example, in some implementations, the server(s) 204 used to implement the computing system 100 may be included amongst the access management server(s) 204a of the access management system 506 and/or the storage control server(s) 204b of the storage system 508 described in Section E.

As illustrated in FIG. 1A, the client device 202 (examples of which are described in Sections B-D below) may be utilized by a user 102. Although only one such client device 202 is shown in FIG. 1A, it should be appreciated that additional client devices 202 may be employed in some implementations. Although not show in FIG. 1A, it should be appreciated that the client device 202 may be in communication with the computing system 100 using one or more networks 206 (examples of which are described below). In some implementations, a file sharing application may be installed on the client device 202 and the user 102 may use such a file sharing application to request the download of the first file 104 from the computing system 100. In some implementations, the user 102 of client device 202 may alternatively use a web-based file sharing application (accessed via a browser on the client device 202) to request the download of the first file 104 from the computing system 100. The file management application 513 described in Section E (in connection with FIG. 5A) is an example of a file sharing application that may be used for such purposes. In this disclosure, file sharing applications installed on client devices 202 are referred to as a “local” file management applications 513a, and file sharing applications executing on web servers are referred to as “web-based” file sharing applications 513b. An example routine 120 that may be performed by the computing system 100 is illustrated in FIG. 1A.

As shown in FIG. 1A, at a step 122 of the routine 120, the computing system 100 may (as indicated by an arrow 101) receive a first request to download the first file 104 to a client device 202. In some implementations, for example, the first request of the step 122 may correspond to an access request 514 (see FIG. 5C) a file management application 513a, 513b (either local or web-based based) sends to the access management system 506 of the file sharing system 504. As Section E explains, based upon the receipt of such an access request, the access management system 506 may send an access token corresponding to the first file 104 to the file management application 513a, 513b (e.g., see step 522 in FIG. 5C). For instance, in response to receiving the access request from the client device 202, the access management system 506 may obtain the access token from the storage system 508 (see the steps 516 and 520 in FIG. 5C).

Alternatively, in some implementations, the first request of the step 122 may correspond to a file transfer request 524 (see FIG. 5C) that the client device 202 sends (e.g., via a browser) to the storage system 508 of the file sharing system 504. For example, such a request may be sent to the storage system 508 in response to the user selecting a file access link that was previously provided by the access management system 506. As Section E explains, in some implementations, such a file access link may include an access token for the first file 104, and the storage system 508 may be configured to send the first file 104 to the client device 202 (e.g., see step 528 in FIG. 5C) in response to receiving that access token from the client device 202.

At a step 124 of the routine 120, the computing system 100, based at least in part on the first request, may (as indicated by an arrow 103 in FIG. 1A) send a first digest corresponding to the first file 104 to the client device 202 to enable the client device 202 to compare the first digest with at least a second digest corresponding to a second file stored locally, such as in a local storage 108, at the client device 202. In some implementations, such as where the first request of the step 122 corresponds to an access request 514 (see FIG. 5C) sent from a file management application 513a, 513b to the access management system 506, the first digest of the step 124 may be sent from the access management system 506 to the client device 202 (e.g., to a local file management application 513a). In other implementations, such as where the first request of the step 122 corresponds to a file transfer request 524 (see FIG. 5C) sent from the client device 202 to the storage system 508, the first digest of the step 124 may be sent from the storage system 508 to the client device 202 (e.g., to a local file management application 513a). In either case, the first digest that is sent from the computing system 100 to the client device 202 may be a cryptographic hash of the first file 104 stored at the computing system 100. Such a digest may be determined, for example, using a suitable digest generation process, such as Message Digest 5 (MD5), Secure Hash Algorithm-256 (SHA-256), Secure Hash Algorithm-512 (SHA-512), or Research and Development in Advanced Communications Technologies in Europe (RACE) Integrity Primitives Evaluation Message Digest (RIPEMD-128).

At a step 126 of the routine 120, the computing system 100, after sending the first digest to the client device 202, may (as indicated by an arrow 105 in FIG. 1A) receive a second request to refrain from downloading the first file 104 to the client device 202. In some implementations, as referenced in the step 124, the client device 202 (e.g., via a local file management application 513a) may determine, based on a comparison of the first digest with the second digest(s) for locally stored files, that the first file 104 is presently stored locally on the client device 202. Based on this determination, the client device 202 (e.g., via the local file management application 513a) may send the second request to the computing system 202 to refrain from downloading the first file 104, since the client device 202 currently has the first file 104 in its local storage 108. In some implementations, such as where the first request of the step 122 corresponds to an access request 514 (see FIG. 5C) sent from a file management application 513a, 513b (either local or web-based) to the access management system 506, the second request of the step 126 may correspond to a message sent from the file management application 513a, 513b to the access management system 506 that causes the access management system 506 to refrain from sending the access token for the first file 104 to the file management application 513a, 513b and/or to instruct the storage system 508 to no longer permit access to the first file 104 using the access token (e.g., if the access token was already provided to the file management application 513a, 513b). In other implementations, such as where the first request of the step 122 corresponds to a file transfer request 524 (see FIG. 5C) sent from the client device 202 (e.g., via a browser) to the storage system 508, the second request of the step 126 may correspond to a message sent from the client device 202 (e.g., via a local file management application 513a) to the storage system 508 instructing the storage system 508 to refrain from transferring the first file 104 identified by the access token to the client device 202.

In any event, in some implementations, the file management application 513a, 513b may cause the client device 202 to output to the user 102 (e.g., via a display 107 of the client device 202) the results of the comparison of the first digest with the second digest(s) for locally stored files. In some implementations, the comparison results that are so output may be in response to a determination, based at least in part on the comparison, that the first file 104 is presently stored in the local storage 108 of the client device 202. In some implementations, the file management application 513a, 513b may send the second request (per the arrow 106) in response to receiving an input from the user 102 at the client device 202 based on the output comparison results.

FIG. 1B is a high-level diagram illustrating a client device 202 (e.g., via a local file management application 513a) orchestrating duplicate detection of the first file 104 requested for the client device 202, in accordance with some embodiments of the present disclosure. As shown in FIG. 1B, at a step 132 of the routine 130, the client device 202 (e.g., via the local file management application 513a) may determine that the user 102 has requested to download the first file 104 that is stored by the computing system 100. The client device 202 may, for example, determine that the user 102 has provided an input to the client device 202 (e.g., via a file management application 513a, 513b) requesting that the first file 104 be downloaded. In some implementations, such a user input may correspond the user 102 operating the file management application 513a, 513b (either local or web-based) to select the first file 104 from a list of files presented on the display 107 of the client device 202 and to request that the first file 104 be downloaded to the client device 202. For instance, as described in Section E, in some implementations, the access management system 506 may store metadata indicative of files that are stored at the storage system 508, and may cause the file management application 513a, 513b to present a user interface on the client device 202 that identifies such files and permits the user 102 of the client device 202 to select one or more of the indicated files for download to the client device 202.

In other implementations, the client device 202 (e.g., a local file management application 513a) may determine that the client device 202 has sent a file transfer request 524 (see FIG. 5C) to the storage system 508 and/or that the client device 202 has received a response to such a request, and may make the determination of the step 132 based on such request and/or response. As noted above, in some implementations, such a request to download the first file 104 may include an access token for the first file 104, with the access token being configured to enable a secure transfer of the first file 104 from the computing system 100 to the client device 202. In still other implementations, the client device 202 (e.g., a local file management application 513a) may detect a user input indicating that such a request for the first file 104 is to be sent to the storage system 508, prior to the request actually being sent to the storage system 508. For example, in some implementations, the local file management application 513a may detect that a user has selected a link (possibly including an access token) for accessing the storage system 508, and may make the determination of the step 132 before a file transfer request 524 (see FIG. 5C) is sent to the storage system 508 via a browser or otherwise.

At a step 134 of the routine 130, the client device 202 (e.g., a local file management application 513a) may, as indicated by the arrow 103 in FIG. 1B, receive from the computing system 100 a first digest corresponding to the first file 104. In some implementations, the first digest of the step 134 may be received from the access management system 506 of the file sharing system 504 (shown in FIGS. 5A-C). For instance, in circumstances in which a file management application 513a, 513b (either local or web-based) sends an access request 514 (see FIG. 5C) to the access management system 506, the client device 202 may receive the first digest from the access management system 506 in response to such an access request. In some such implementations, the first digest may accompany an access link/token for the first file 104 (per the step 522 in FIG. 5C). In some implementations, the first digest may even be included as a part of the link/access token. In implementations in which the first digest accompanies and/or is a part of the link/access token for the first file 104, the first digest may be transferred along with the link/access token, such that the step 134 may correspond to receipt of such link/access token/first digest, either from the access management system 506, or from any other computing device, e.g., another client device 202, that previously received the link/access token/first digest from the access management system 506.

In other implementations, the first digest may be received from the access management system 506 separately (e.g., prior to or after) receipt of an access token for the first file 104. In still other such implementations, the access management system 506 may send an access token for the first file 104 to the file management application 513a, 513b only if, in response to sending the first digest to the client device 202 (e.g., to a local file management application 513a), a message is received from confirming that the file download is to proceed as requested (e.g., either because no duplicate files were found on the client device 202 or because the user 102 has opted to proceed with a download in spite of the detection of a duplicate local file, as described below).

In other implementations, the first digest of the step 134 may be received from the storage system 508 of the file sharing system 504 (shown in FIGS. 5A-C). In some such implementations, for example, in response to receiving a file transfer request 524 (see FIG. 5C) for the first file 104, the storage system 508 may send the first digest for the first file 104 to the client device 202 (e.g., to a local file management application 513a).

At a step 136 of the routine 130, the client device 202 (e.g., a local file management application 513a) may determine that the first digest for the first file 104 (received per the step 134) matches at least a second digest for a second file stored locally, such as in the local storage 108, at the client device 202. As described in more detail below, the client device 202 may maintain digests for the individual files that are stored in the local storage 108, and the step 136 may involve a comparison of the first digest (received per the step 134) with the respective digests for such locally stored files.

At a step 138 of the routine 130, the client device 202 (e.g., via a file management application 513a, 513b), based at least in part on the first digest (received per the step 134) matching the second digest for a locally stored file, may output an indication that at least a portion of the first file 104 is stored locally, such as in the local storage 108, at the client device 202. As illustrated in FIG. 1B, in some implementations, a file management application 513a, 513b may cause the client device 202 to output, such as via the display 107, a message/prompt 109 and/or one or more user interface elements 111a, 111b that can be selected by the user 102 to indicate whether the first file 104 is to be downloaded in view of the indication that the first file 104 (or portion thereof) is already stored locally at the client device 202.

In some implementations, a file management application 513a, 513b may determine that a user input (e.g., selection of the user interface element 111a) indicates that the first file 104 is not to be downloaded from the computing system 100. In some such implementations, in response to receiving such a user input, the file management application 513a, 513b may send an indication to the computing system 100 to refrain from downloading the first file 104 from the computing system 100 to the client device 202 (e.g., as described above in connection with the step 126 of the routine 120 (shown in FIG. 1A).

In some implementations, a file management application 513a, 513b may determine that a user input (e.g., selection of the user interface element 111b) indicates that the first file 104 is to be downloaded from the computing system 100 in spite of the detected duplicate file (or portion thereof) in the local storage 108 of the client device 202. In some such implementations, in response to receiving such a user input, the file management application 513a, 513b may send an indication to the computing system 100 to proceed with downloading the first file 104 from the computing system 100 to the client device 202.

In some implementations, the client device 202 (e.g., a local file management application 513) may determine that the first digest for the first file 104 (received per the step 134) does not match a second digest for a second file stored locally, such as in the local storage 108, at the client device 202. In such a case, a file management application 513a, 513b may instruct the file sharing system 504 to continue with the download of the first file 104, such as by sending an access token for the file to the storage system 508 or otherwise.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), interne protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

### C. Computing Environment

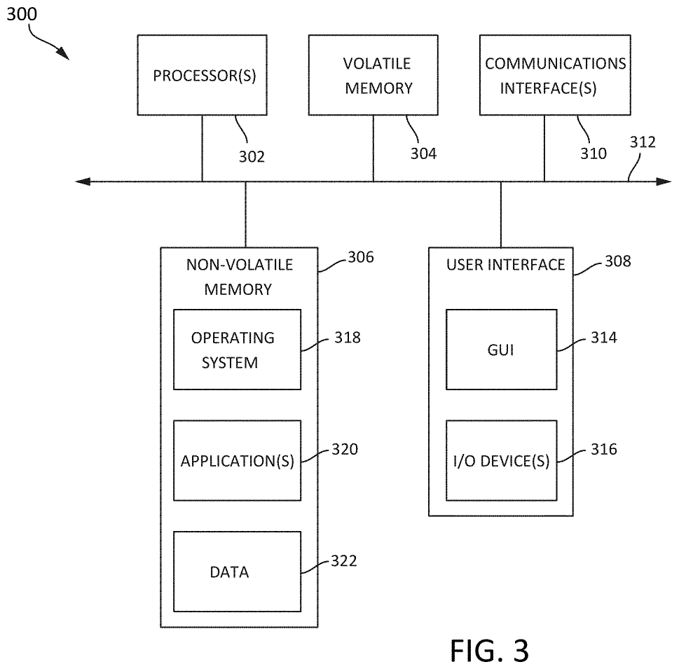

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

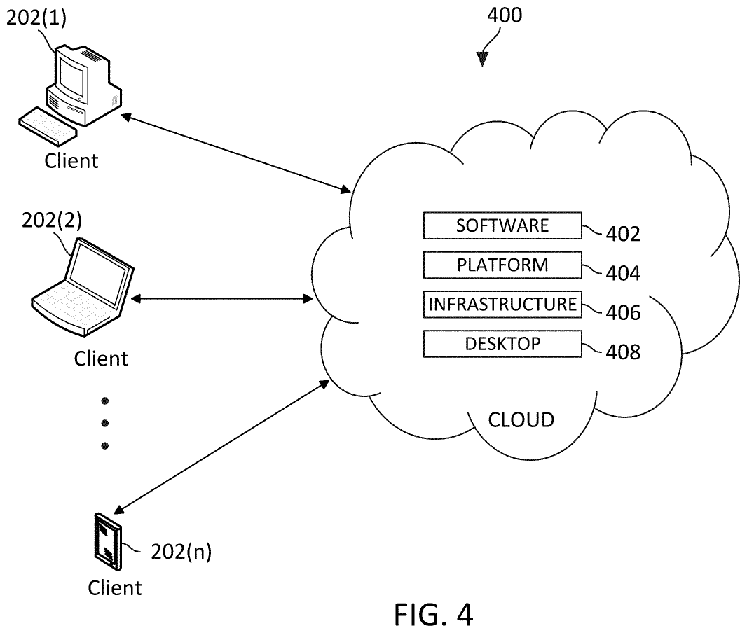

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile° mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a file transfer request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

F. Detailed Description of Example Embodiments of a File Download System with Duplicate Detection

As described above in Section A, at a high level, the computing system 100 (shown in FIGS. 1A and 1B) may receive a request to download the first file 104 to a client device 202. The computing system may send a first digest for the first file 104 to the client device 202 (e.g., to a local file management application 513a). The client device 202 (e.g., the local file management application 513a) may compare the first digest for the first file 104 to one or more digests of files stored in the local storage 108 of client device 202. In some implementations, a file management application 513a, 513b may cause the client device 202 to output, or display, an indication (e.g., the message/prompt 109 and/or the user interface elements 111a, 111b shown in FIG. 1B) that at least a portion of first file 104 is stored in the local storage 108 of the client device 202.

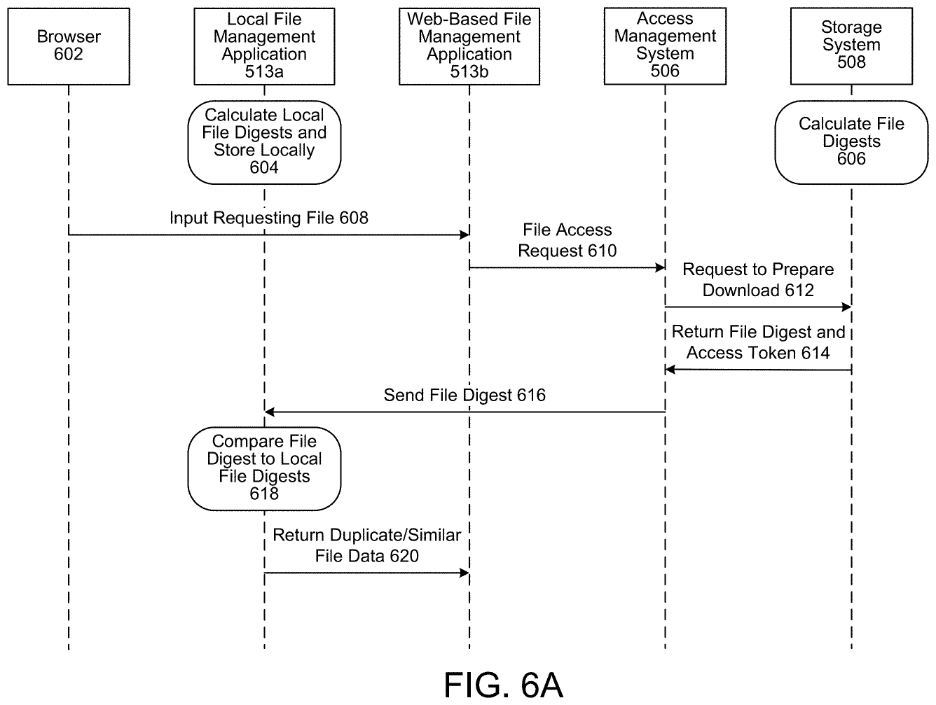

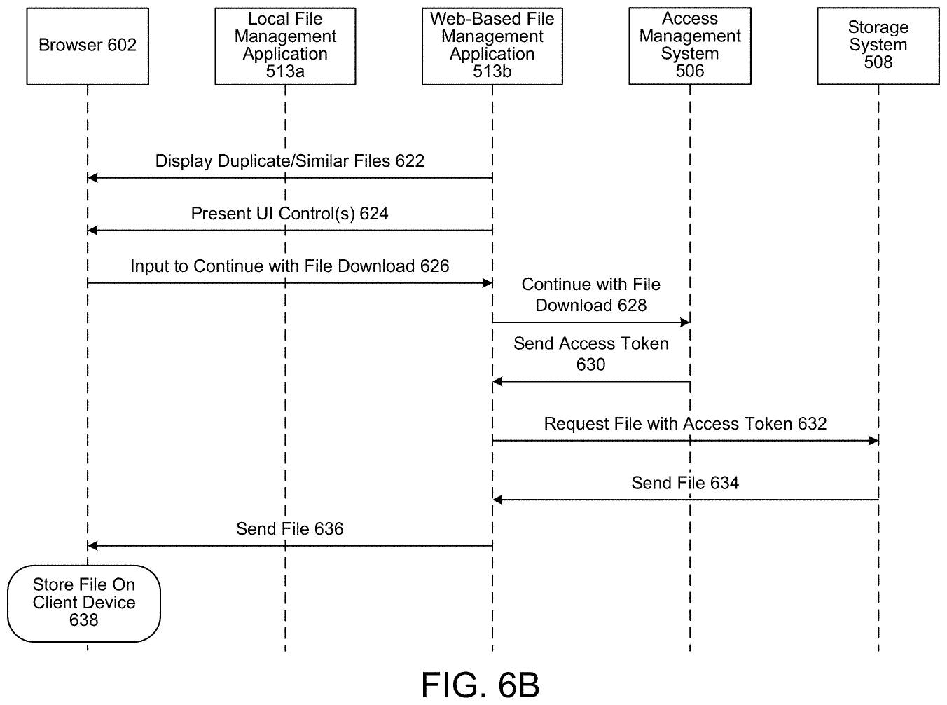

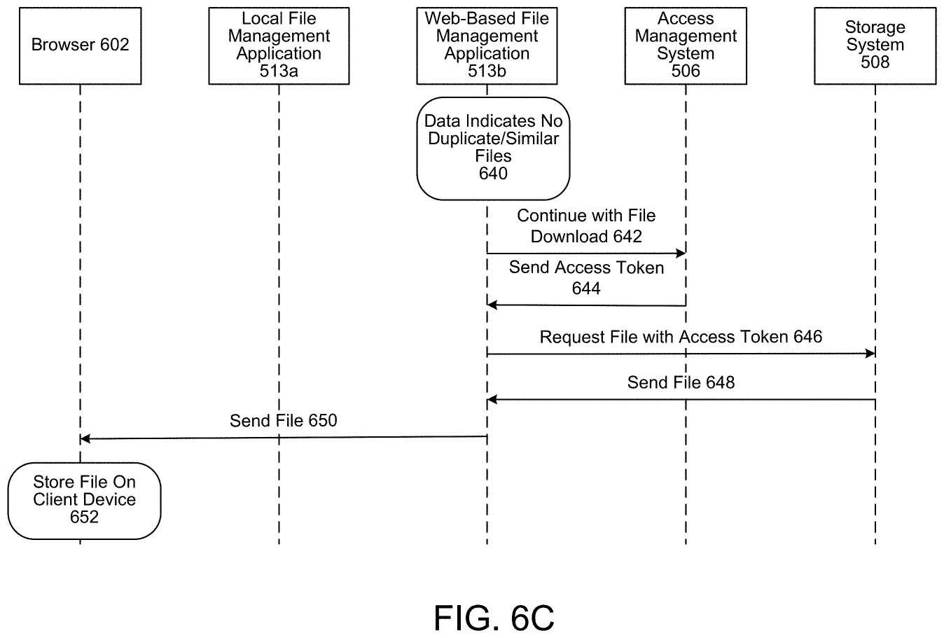

FIGS. 6A-6C illustrate an example process for a file download, with duplicate detection, that involves a file download request sent from a web-based file management application 513b to an access management system 506 of the file sharing system 504, in accordance with some embodiments. As described above in connections with FIGS. 1A and 1B, in some implementations, a user 102 may operate a browser 602 of a client device 202 to access a web-based file management application 513b to request the download a first file 104 from a file sharing system 504 (e.g., by sending an access request to an access management system 506 of the file sharing system 504). The web-based file management application 513b may, for example, be a web-based version of the file management application 513 described in Section E (in connection with FIG. 5A). As shown in FIGS. 6A-C, in addition to such a web-based file management application 513b, the illustrated process may also involve a local file management application 513a that is installed on the client device 202. The local file management application 513a may, for example, correspond to the ShareFile® mobile application or the ShareFile® desktop application offered by Citrix Systems, Inc.

As shown in FIG. 6A, the local file management application 513a may calculate (604) one or more file digests for one or more files stored locally at the client device 202, e.g., within the local storage 108 shown in FIGS. 1A-B. In some implementations, and as described above, such file digests may be cryptographic hashes of the locally stored files. For example, the file digests may be calculated using a suitable digest generation process, such as MDS, SHA-256, SHA-512, or RIPEMD-128. Additionally or alternatively, in some implementations, the local file management application 513a may calculate (604) file digests for individual files as such files are added to the local storage 108 of the client device 202. In some implementations, the file digests that are calculated by the local file management application 513a may be stored in local memory of the client device 202, e.g., in the local storage 108 or elsewhere. Further, if a file is removed from the local storage 108 of the client device 202, then the local file management application 513a may remove the corresponding file digest from the file digests it maintains in local memory. The user 102 may provide permission for the local file management application 513a to access the storage drives and directories of the client device 202. In some implementations, the local file management application 513a may enable the user 102 to configure the search paths (e.g., “disk C,” “disk D,” etc.) for the storage locations at the client device 202 that are to be searched for files for which such digests are to be calculated.

As also shown in FIG. 6A, in some implementations, the storage system 508 of the file sharing system 504 may similarly calculate (606) one or more digests for the files stored in the file storage 512 (shown in FIGS. 5A and 5C). Similar to the description above for the local file management application 513a of the client device 202, in some implementations, the storage system 508 may additionally or alternatively calculate file digests for individual files as such files are added to the file storage 512 of the storage system 508, and may store such calculated file digests in memory, such as in the file storage 512 or otherwise. Further, if a file is removed from the file storage 512 of the storage system 508, then the storage system 508 may also remove the corresponding file digest from the file digests it maintains in memory.

As illustrated in FIG. 6A, the user 102 of the client device 202 may operate the browser 602 of the client device 202 to provide (608) an input to the web-based file management application 513b to request the first file 104 from the file sharing system 504. For example, as explained above, in some implementations, the web-based file management application 513b may cause the client device 202 (e.g., via the browser 602) to present a user interface identifying various files (stored by the storage system 508) the user 102 is authorized to access. As described in Section E, in some implementations, the identity of such files may be determined based on metadata the access management system 506 maintains (e.g., in the database(s) 510 shown in FIGS. 5A and 5C) for the files stored by the storage system 508.

In response to receiving (608) an input from the browser 602, the web-based file management application 513b may send (610) an access request 514 (also described in connection with FIG. 5C) for the first file 104 to the access management system 506.

In response to receiving (610) the file access request 514 from the web-based file management application 513b, the access management system 506 may send (612) a “prepare” message 516 (see FIG. 5C) to the storage system 508 requesting that the first file 104 be prepared for download.

In response to the storage system 608 receiving (612) such a “prepare” message 516, in addition to generating and returning (614) an access token for the first file 104 (as described in connection with FIG. 5C), the storage system 508 may also retrieve and return (614) the file digest for the first file 104 (e.g., as calculated per the step 606).

In some implementations, the access management system 506 and/or the storage system 508 may be configured with a file size threshold, such that the access management system 506 may request file digests from the storage system 508 and/or the storage system 508 may return (614) file digests to the access management system 506 for files which exceed the file size threshold. The use of such a file size threshold may be beneficial, for example, for scenarios in which the transfer of smaller files may not be considered a burden on the file sharing system 504.

Still referring to FIG. 6A, in some implementations, the access management system 506 may send (616) the file digest of the first file 104 to the local file management application 513a of the client device 202. The local file management application 513a may then compare (618) the file digest for the first file 104 to one or more file digests for files stored locally on the client device 202 (e.g., as calculated per the step 604). In some implementations, the local file management application 513a may determine if the same file as the first file 104 (i.e., a duplicate) is presently stored on the client device 202 using the file digest of the first file 104 and the one or more file digests for the locally stored files. In some implementations, such a duplicate determination may be based on comparing the file digest of the first file 104 and the one or more locally stored file digests and determining if one or more matches are identified.

In some implementations, the local file management application 513a may additionally or alternatively determine if one or more files similar to the first file 104 are presently stored on the client device 202. In such implementations, in addition to or in lieu of calculating a single digest for a file, such as at the step 604 for the local file management application 513a and the step 606 for the storage system 508, a file may be divided into segments (e.g., two kilobyte chunks) and individual digests may be calculated for respective segments. In such implementations, the storage system 508 may return (614) one or more segment digests associated with the first file 104, and the access management system 506 may pass those segment digests to the local file management application 513a for evaluation per the step 618. The local file management application 513a may thus compare (618) the one or more segment digests of first file 104 to one or more segment digests associated with the individual files stored on the client device 202. By comparing the segment digests, and based on the number of segments digests that match between the first file 104 and individual files stored on the client device 202, the local file management application 513a may determine if the files are similar. In some implementations, a similarity value, such as a percentage, may be determined based on the number of matching segment digests. For example, if only a single character is different between the first file 104 and a file stored locally on the client device, then the local file management application 513a may determine, by comparing segment digests, that the two files have a very high similarity. However, using whole file digests for comparison may not have identified that the client device 202 had a locally stored file that is nearly identical to first file 104.

In some implementations, the local file management application 513a may send (620) data indicative of one or more duplicate files and/or one or more similar files from the comparison at the step 618 to the web-based file management application 513b from which the original access request 514 was received (per the step 610).

FIG. 6B illustrates a first circumstance in which the data sent to the web-based file management application 513b indicates that one or more duplicate and/or similar files are present on the client device 202. As shown, in that circumstance, the web-based file management application 513b may instruct (622) the browser 602 to cause the client device 202 to display an indication of the duplicate and/or similar file(s), e.g., as illustrated by the message/prompt 109 shown in FIG. 1B. In some implementations, the web-based file management application 513b may further instruct (622) the browser 602 to cause the client device 202 to display additional information concerning the duplicate/similar file(s), such as the file name, file path, the last modified date, and the file size for such file(s).

In some implementations, the web-based file management application 513b may additionally or alternatively instruct (624) the browser 602 provide one or more user interface (UI) controls, such as one or more buttons, that may be selected by the user 102 of the client device 202 to open the file(s) on the client device 202 that are indicated as being duplicative of and/or similar to the first file 104. Further, in some implementations, the web-based file management application 513b may additionally or alternatively instruct (624) the browser 602 provide one or more UI controls, such as one or more buttons, that can be selected by the user 102 to indicate whether to proceed with the requested download of the first file 104 in spite of the indicated duplicate and/or similar file(s). As described in connection with FIG. 1B, for example, in some implementations, the web-based file management application 513b may instruct (624) the browser 602 to present user interface elements 111a, 111b that can be selected by the user 102 to indicate whether the first file 104 is to be downloaded in view of the indication that the first file 104 (or portion thereof) is already stored locally at the client device 202.

In some scenarios, the user 102 may operate the browser 602 to provide an input to the web-based a file management application 513b (e.g., in response to the selection of the user interface element 111a shown in FIG. 1B) indicating that the first file 104 is not to be downloaded from the file sharing system 504 in view of the detected duplicate file (or portion thereof) in the local storage 108 of the client device 202. In such a scenario, which is not illustrated in FIG. 6B, in response to receiving such a user input, the web-based file management application 513b may send an indication to the access management system 506 to refrain from downloading the first file 104 to the client device 202 (e.g., as described above in connection with the step 126 of the routine 120 (shown in FIG. 1A).

In other scenarios, as illustrated in FIG. 6B, the user 102 may operate the browser 602 to provide (626) an input to the web-based file management application 513b (e.g., in response to the selection of the user interface element 111b shown in FIG. 1B) indicating that the first file 104 is to be downloaded from the file sharing system 504 in spite of the detected duplicate file (or portion thereof) in the local storage 108 of the client device 202.

In response to the web-based file management application 513b receiving (626) such an input indicating that the download process is to continue, the web-based file management application 513b may send (628) an instruction to the access management system 506 to continue with the process for downloading the first file 104.

In response to receiving (628) the instruction from the web-based file management application 513b, the access management system 506 may send (630) the access token for the first file 104 (e.g., as received from the storage system 508 per the step 614 shown in FIG. 6A) to the web-based file management application 513b.

Upon receiving (630) the access token from the access management system 506, the web-based file management application 513b may send (632) a file transfer request 524, including the access token for the first file (e.g., as described in connection with FIG. 5C) to the storage system 508.

In response to receiving (632) the file transfer request 524 from the web-based file management application 513b, the storage system 508 may use the access token to retrieve the first file 104 from the file storage 512, and may send (634) the first file 104 to the web-based file management application 513b. The web-based file management application 513b may then send (636) the first file 104 to the browser 602, and the browser 602 may cause (638) the first file 104 to be stored on the client device 202, e.g., within the local storage 108 shown in FIGS. 1A and 1B.

FIG. 6C illustrates a second circumstance in which the data sent to the web-based file management application 513b (per the step 620) indicates that no duplicate and/or similar files are present on the client device 202.

As shown in FIG. 6C, upon receiving (620) the data from local file management application 513a, the web-based file management application 513b may determine (640) that the received data indicates that no duplicate and/or similar files are stored at the client device 202. In response to making such a determination, the web-based file management application 513b may send (642) an instruction to the access management system 506 to continue with the process for downloading the first file 104.

In response to receiving (642) the instruction from the web-based file management application 513b, the access management system 506 may send (644) the access token for the first file 104 (e.g., as received from the storage system 508 per the step 614 shown in FIG. 6A) to the web-based file management application 513b.

Upon receiving (644) the access token from the access management system 506, the web-based file management application 513b may send (646) a file transfer request 524, including the access token for the first file (e.g., as described in connection with FIG. 5C) to the storage system 508.

In response to receiving (646) the file transfer request 524 from the web-based file management application 513b, the storage system 508 may use the access token to retrieve the first file 104 from the file storage 512, and may send (648) the first file 104 to the web-based file management application 513b. The web-based file management application 513b may then send (650) the first file 104 to the browser 602, and the browser 602 may cause (652) the first file 104 to be stored on the client device 202, e.g., within the local storage 108 shown in FIGS. 1A and 1B.

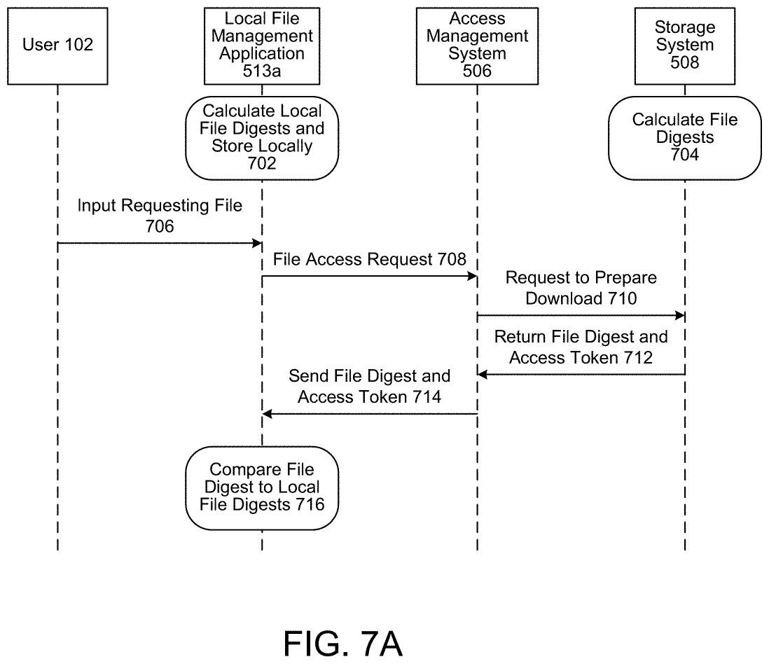

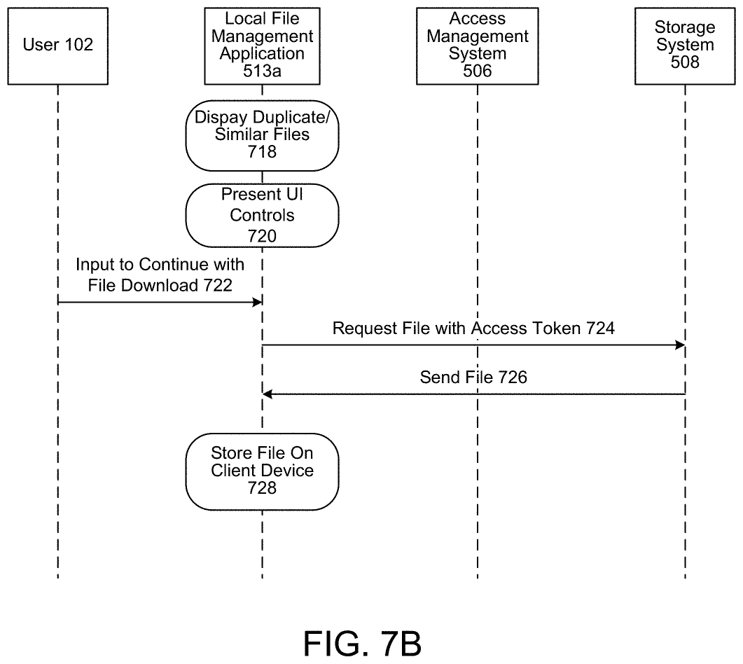

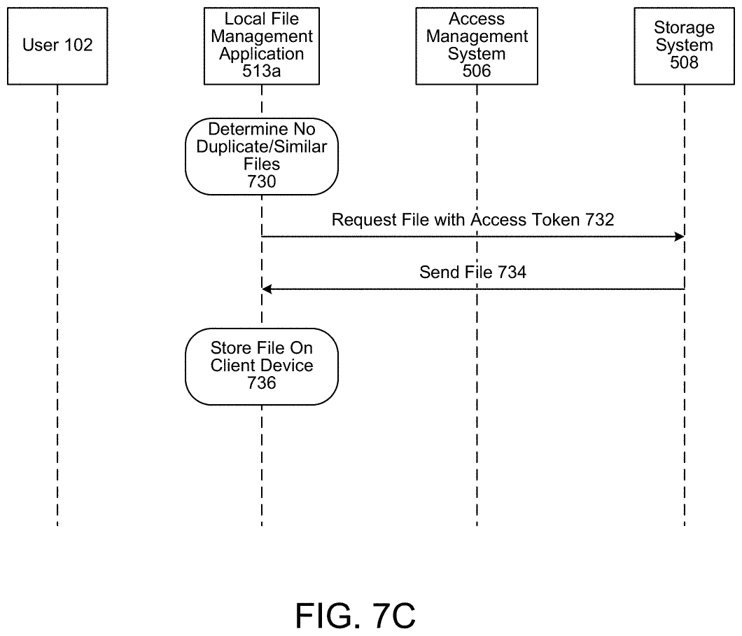

FIGS. 7A-7C illustrate an example process for a file download, with duplicate detection, that involves a file download request sent from a local file management application 513a to an access management system 506 of the file sharing system 504, in accordance with some embodiments. As described above in connections with FIGS. 1A and 1B, in some implementations, a user 102 may interact with a local file management application 513a (resident on the client device 202) to request the download a first file 104 from a file sharing system 504 (e.g., by sending an access request to an access management system 506 of the file sharing system 504). The local file management application 513a may, for example, correspond to the ShareFilex® mobile application or the ShareFile® desktop application offered by Citrix Systems, Inc.

As shown in FIG. 7A, the local file management application 513a may calculate (702) one or more file digests for one or more files stored locally at the client device 202, e.g., within the local storage 108 shown in FIGS. 1A-B. In some implementations, and as described above, such file digests may be cryptographic hashes of the locally stored files. For example, the file digests may be calculated using a suitable digest generation process, such as MD5, SHA-256, SHA-512, or RIPEMD-128. Additionally or alternatively, in some implementations, the local file management application 513a may calculate (702) file digests for individual files as such files are added to the local storage 108 of the client device 202. In some implementations, the file digests that are calculated by the local file management application 513a may be stored in local memory of the client device 202, e.g., in the local storage 108 or elsewhere. Further, if a file is removed from the local storage 108 of the client device 202, then the local file management application 513a may remove the corresponding file digest from the file digests it maintains in local memory. The user 102 may provide permission for the local file management application 513a to access the storage drives and directories of the client device 202. In some implementations, the local file management application 513a may enable the user 102 to configure the search paths (e.g., “disk C,” “disk D,” etc.) for the storage locations at the client device 202 that are to be searched for files for which such digests are to be calculated.

As also shown in FIG. 7A, in some implementations, the storage system 508 of the file sharing system 504 may similarly calculate (704) one or more digests for the files stored in the file storage 512 (shown in FIGS. 5A and 5C). Similar to the description above for the local file management application 513a of the client device 202, in some implementations, the storage system 508 may additionally or alternatively calculate file digests for individual files as such files are added to the file storage 512 of the storage system 508, and may store such calculated file digests in memory, such as in the file storage 512 or otherwise. Further, if a file is removed from the file storage 512 of the storage system 508, then the storage system 508 may also remove the corresponding file digest from the file digests it maintains in memory.

As illustrated in FIG. 7A, the user 102 of the client device 202 may provide (706) an input to the local file management application 513a to request the first file 104 from the file sharing system 504. For example, as explained above, in some implementations, the local file management application 513a may cause the client device 202 to present a user interface identifying various files (stored by the storage system 508) the user 102 is authorized to access. As described in Section E, in some implementations, the identity of such files may be determined based on metadata the access management system 506 maintains (e.g., in the database(s) 510 shown in FIGS. 5A and 5C) for the files stored by the storage system 508.

In response to receiving (706) the input from the user 102, the local file management application 513a may send (708) an access request 514 (also described in connection with FIG. 5C) for the first file 104 to the access management system 506.

In response to receiving (708) the access request 514 from the local file management application 513a, the access management system 506 may send (710) a “prepare” message 516 (see FIG. 5C) to the storage system 508 requesting that the first file 104 be prepared for download.

In response to the storage system 608 receiving (710) such a “prepare” message 516, in addition to generating and returning (712) an access token for the first file 104 (as described in connection with FIG. 5C), the storage system 508 may also retrieve and return (712) the file digest for the first file 104 (e.g., as calculated per the step 704).

In some implementations, the access management system 506 and/or the storage system 508 may be configured with a file size threshold, such that the access management system 506 may request file digests from the storage system 508 and/or the storage system 508 may return (712) file digests to the access management system 506 only for files which exceed the file size threshold. The use of such a file size threshold may be beneficial, for example, for scenarios in which the transfer of smaller files may not be considered a burden on the file sharing system 504.

Still referring to FIG. 7A, in some implementations, the access management system 506 may send (714) the file digest of the first file 104 and the access token for the first file 104 to the local file management application 513a of the client device 202. The local file management application 513a may then compare (716) the file digest for the first file 104 to one or more file digests for files stored locally on the client device 202 (e.g., as calculated per the step 702). In some implementations, the local file management application 513a may determine if the same file as the first file 104 (i.e., a duplicate) is presently stored on the client device 202 using the file digest of the first file 104 and the one or more file digests for the locally stored files. In some implementations, such a duplicate determination may be based on comparing the file digest of the first file 104 and the one or more locally stored file digests and determining if one or more matches are identified.

In some implementations, the local file management application 513a may additionally or alternatively determine if one or more files similar to the first file 104 are presently stored on the client device 202. In such implementations, in addition to or in lieu of calculating a single digest for a file, such as at the step 702 for the local file management application 513a and the step 704 for the storage system 508, a file may be divided into segments (e.g., two kilobyte chunks) and individual digests may be calculated for respective segments. In such implementations, the storage system 508 may return (712) one or more segment digests associated with the first file 104, and the access management system 506 may pass those segment digests to the local file management application 513a for evaluation per the step 716. The local file management application 513a may thus compare (716) the one or more segment digests of first file 104 to one or more segment digests associated with the individual files stored on the client device 202. By comparing the segment digests, and based on the number of segments digests that match between the first file 104 and individual files stored on the client device 202, the local file management application 513a may determine if the files are similar. In some implementations, a similarity value, such as a percentage, may be determined based on the number of matching segment digests. For example, if only a single character is different between the first file 104 and a file stored locally on the client device, then the local file management application 513a may determine, by comparing segment digests, that the two files have a very high similarity. However, using whole file digests for comparison may not have identified that the client device 202 had a locally stored file that is nearly identical to first file 104.

FIG. 7B illustrates a first circumstance in which the local file management application 513a determines (per the step 716) that one or more duplicate and/or similar files are present on the client device 202. As shown, in that circumstance, the local file management application 513a may cause (718) the client device 202 to display an indication of the duplicate and/or similar file(s), e.g., as illustrated by the message/prompt 109 shown in FIG. 1B. In some implementations, the local file management application 513a may further cause (718) the client device 202 to display additional information concerning the duplicate/similar file(s), such as the file name, file path, the last modified date, and the file size for such file(s).

In some implementations, the local file management application 513a may additionally or alternatively cause (720) the client device 202 to present one or more user interface (UI) controls, such as one or more buttons, that can be selected by the user 102 of the client device 202 to open the file(s) on the client device 202 that are indicated as being duplicative of and/or similar to the first file 104. Further, in some implementations, the local file management application 513a may additionally or alternatively cause (720) the client device 202 to present one or more UI controls, such as one or more buttons, that can be selected by the user 102 to indicate whether to proceed with the requested download of the first file 104 in spite of the indicated duplicate and/or similar file(s). As described in connection with FIG. 1B, for example, in some implementations, the local file management application 513a may cause the client device 202 to present user interface elements 111a, 111b that can be selected by the user 102 to indicate whether the first file 104 is to be downloaded in view of the indication that the first file 104 (or portion thereof) is already stored locally at the client device 202.

In some scenarios, the user 102 may provide an input to the local file management application 513a (e.g., in response to the selection of the user interface element 111a shown in FIG. 1B) indicating that the first file 104 is not to be downloaded from the file sharing system 504 in view of the detected duplicate file (or portion thereof) in the local storage 108 of the client device 202. In such a scenario, which is not illustrated in FIG. 7B, in response to receiving such a user input, the local file management application 513a may send an indication to the access management system 506 to refrain from downloading the first file 104 to the client device 202 (e.g., as described above in connection with the step 126 of the routine 120 (shown in FIG. 1A).

In other scenarios, as illustrated in FIG. 7B, the user 102 may provide (722) an input to the local file management application 513a (e.g., in response to the selection of the user interface element 111b shown in FIG. 1B) indicating that the first file 104 is to be downloaded from the file sharing system 504 in spite of the detected duplicate file (or portion thereof) in the local storage 108 of the client device 202.

In response to the local file management application 513a receiving (722) such an input indicating that the download process is to continue, the local file management application 513a may send (724) a file transfer request 524, including the access token for the first file (e.g., as described in connection with FIG. 5C), to the storage system 508.

In response to receiving (724) the file transfer request 524 from the local file management application 513a, the storage system 508 may use the access token to retrieve the first file 104 from the file storage 512, and may send (726) the first file 104 to the local file management application 513a. The local file management application 513a may then cause (728) the first file 104 to be stored on the client device 202, e.g., within the local storage 108 shown in FIGS. 1A and 1B.

FIG. 7C illustrates a second circumstance in which the local file management application 513a determines (per the comparison at the step 716) that no duplicate and/or similar files are present on the client device 202.

As shown in FIG. 7C, the local file management application 513a may determine (730) that no duplicate and/or similar files are stored at the client device 202. In response to making such a determination, the local file management application 513a may send (732) a file transfer request 524, including the access token for the first file (e.g., as described in connection with FIG. 5C) to the storage system 508.

In response to receiving (732) the file transfer request 524 from the local file management application 513a, the storage system 508 may use the access token to retrieve the first file 104 from the file storage 512, and may send (734) the first file 104 to the local file management application 513a. The local file management application 513a may then cause (736) the first file 104 to be stored on the client device 202, e.g., within the local storage 108 shown in FIGS. 1A and 1B.

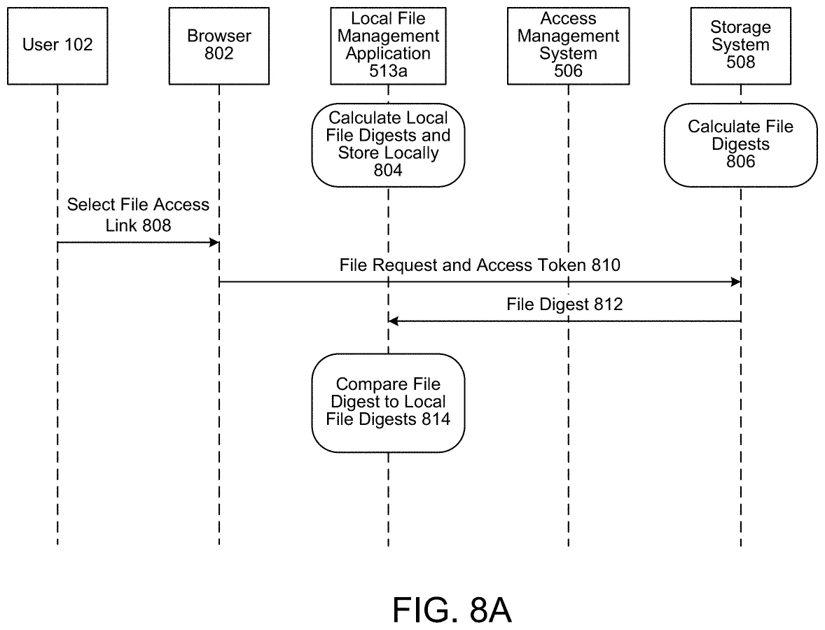

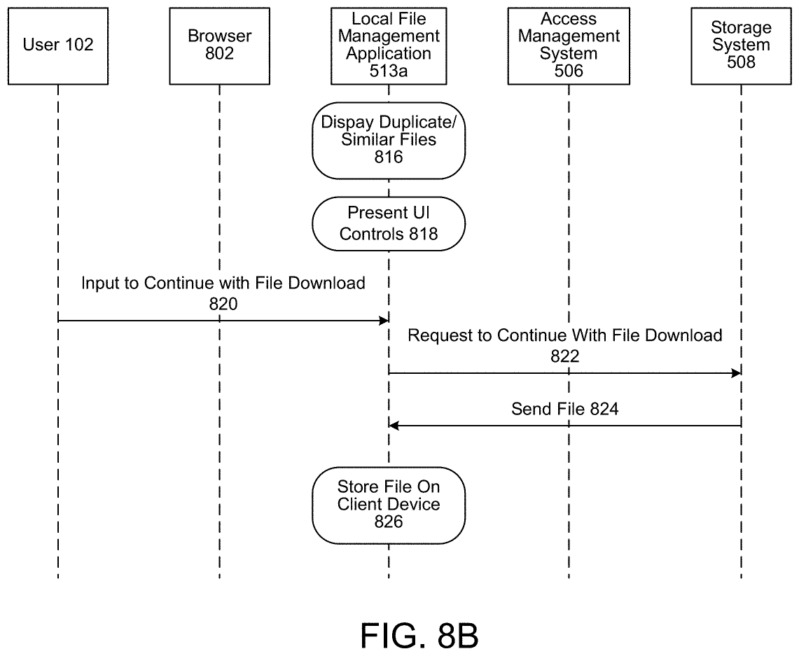

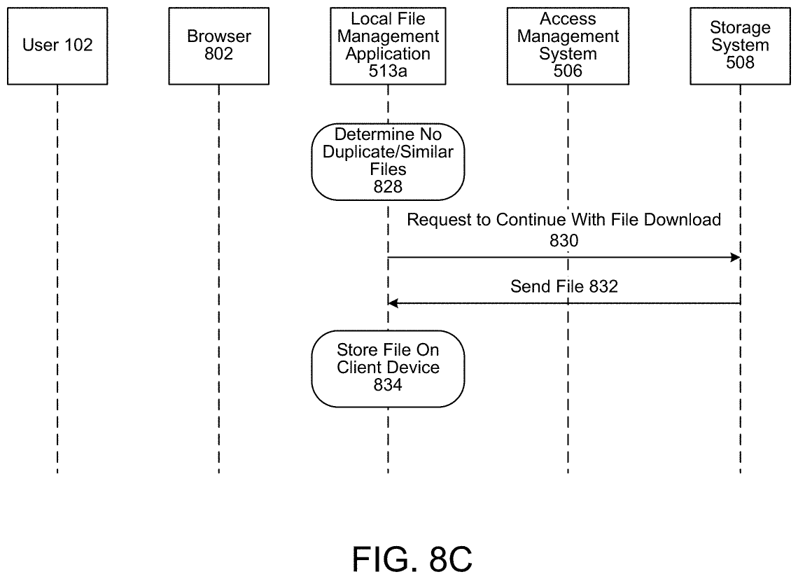

FIGS. 8A-8C illustrate an example process for a file download, with duplicate detection, that involves a file transfer request 524 sent from a client device 202 (e.g., via a browser 802 of a client device 202) to the storage system 508 of the file sharing system 504, in accordance with some embodiments. As described above in Section A, for example, such a file transfer request 524 may be sent to the storage system 508 in response to the user 102 selecting a file access link that was previously provided by the access management system 506. As Section E explains, in some implementations, such a file access link may include an access token for the first file 104, and the storage system 508 may be configured to send the first file 104 to the client device 202 (e.g., see step 528 in FIG. 5C) in response to receiving that access token from the client device 202. The local file management application 513a shown in FIGS. 8A-C may, for example, correspond to the ShareFile® mobile application or the ShareFile® desktop application offered by Citrix Systems, Inc.

As shown in FIG. 8A, the local file management application 513a may calculate (804) one or more file digests for one or more files stored locally at the client device 202, e.g., within the local storage 108 shown in FIGS. 1A-B. In some implementations, and as described above, such file digests may be cryptographic hashes of the locally stored files. For example, the file digests may be calculated using a suitable digest generation process, such as MD5, SHA-256, SHA-512, or RIPEMD-128. Additionally or alternatively, in some implementations, the local file management application 513a may calculate (804) file digests for individual files as such files are added to the local storage 108 of the client device 202. In some implementations, the file digests that are calculated by the local file management application 513a may be stored in local memory of the client device 202, e.g., in the local storage 108 or elsewhere. Further, if a file is removed from the local storage 108 of the client device 202, then the local file management application 513a may remove the corresponding file digest from the file digests it maintains in local memory. The user 102 may provide permission for the local file management application 513a to access the storage drives and directories of the client device 202. In some implementations, the local file management application 513a may enable the user 102 to configure the search paths (e.g., “disk C,” “disk D,” etc.) for the storage locations at the client device 202 that are to be searched for files for which such digests are to be calculated.

As also shown in FIG. 8A, in some implementations, the storage system 508 of the file sharing system 504 may similarly calculate (806) one or more digests for the files stored in the file storage 512 (shown in FIGS. 5A and 5C). Similar to the description above for the local file management application 513a of the client device 202, in some implementations, the storage system 508 may additionally or alternatively calculate file digests for individual files as such files are added to the file storage 512 of the storage system 508, and may store such calculated file digests in memory, such as in the file storage 512 or otherwise. Further, if a file is removed from the file storage 512 of the storage system 508, then the storage system 508 may also remove the corresponding file digest from the file digests it maintains in memory.

As illustrated in FIG. 8A, in response to the user 102 selecting (808) a file access link, the browser 802 of the client device 202 may send (810) a file transfer request 524, including an access token for the first file (e.g., as described in connection with FIG. 5C), to the storage system 508.

In response to receiving (810) the file transfer request 524 from the browser 802, rather than immediately using the access token to retrieve the first file 104 from the file storage 512, the storage system 508 may instead first use the access token to retrieve the file digest for the first file 104, and may send (812) the retrieved file digest for the first file 104 to the local file management application 513a of the client device 202.

In some implementations, the storage system 508 may be configured with a file size threshold, such that the storage system 508 may send (812) file digests to the local file management application 513a only for files which exceed the file size threshold. The use of such a file size threshold may be beneficial, for example, for scenarios in which the transfer of smaller files may not be considered a burden on the file sharing system 504 of the client device 202.

The local file management application 513a may then compare (814) the file digest for the first file 104 to one or more file digests for files stored locally on the client device 202 (e.g., as calculated per the step 804). In some implementations, the local file management application 513a may determine if the same file as the first file 104 (i.e., a duplicate) is presently stored on the client device 202 using the file digest of the first file 104 and the one or more file digests for the locally stored files. In some implementations, such a duplicate determination may be based on comparing the file digest of the first file 104 and the one or more locally stored file digests and determining if one or more matches are identified.

In some implementations, the local file management application 513a may additionally or alternatively determine if one or more files similar to the first file 104 are presently stored on the client device 202. In such implementations, in addition to or in lieu of calculating a single digest for a file, such as at the step 804 for the local file management application 513a and the step 806 for the storage system 508, a file may be divided into segments (e.g., two kilobyte chunks) and individual digests may be calculated for respective segments. In such implementations, the storage system 508 may send (812) one or more segment digests associated with the first file 104 to the local file management application 513a for evaluation per the step 814. The local file management application 513a may thus compare (814) the one or more segment digests of first file 104 to one or more segment digests associated with the individual files stored on the client device 202. By comparing the segment digests, and based on the number of segments digests that match between the first file 104 and individual files stored on the client device 202, the local file management application 513a may determine if the files are similar. In some implementations, a similarity value, such as a percentage, may be determined based on the number of matching segment digests. For example, if only a single character is different between the first file 104 and a file stored locally on the client device, then the local file management application 513a may determine, by comparing segment digests, that the two files have a very high similarity. However, using whole file digests for comparison may not have identified that the client device 202 had a locally stored file that is nearly identical to first file 104.

FIG. 8B illustrates a first circumstance in which the local file management application 513a determines (per the step 814) that one or more duplicate and/or similar files are present on the client device 202. As shown, in that circumstance, the local file management application 513a may cause (816) the client device 202 to display an indication of the duplicate and/or similar file(s), e.g., as illustrated by the message/prompt 109 shown in FIG. 1B. In some implementations, the local file management application 513a may further cause (816) the client device 202 to display additional information concerning the duplicate/similar file(s), such as the file name, file path, the last modified date, and the file size for such file(s).

In some implementations, the local file management application 513a may additionally or alternatively cause (818) the client device 202 to present one or more user interface (UI) controls, such as one or more buttons, that can be selected by the user 102 of the client device 202 to open the file(s) on the client device 202 that are indicated as being duplicative of and/or similar to the first file 104. Further, in some implementations, the local file management application 513a may additionally or alternatively cause (818) the client device 202 to present one or more UI controls, such as one or more buttons, that can be selected by the user 102 to indicate whether to proceed with the requested download of the first file 104 in spite of the indicated duplicate and/or similar file(s). As described in connection with FIG. 1B, for example, in some implementations, the local file management application 513a may cause the client device 202 to present user interface elements 111a, 111b that can be selected by the user 102 to indicate whether the first file 104 is to be downloaded in view of the indication that the first file 104 (or portion thereof) is already stored locally at the client device 202.

In some scenarios, the user 102 may provide an input to the local file management application 513a (e.g., in response to the selection of the user interface element 111a shown in FIG. 1B) indicating that the first file 104 is not to be downloaded from the file sharing system 504 in view of the detected duplicate file (or portion thereof) in the local storage 108 of the client device 202. In such a scenario, which is not illustrated in FIG. 8B, in response to receiving such a user input, the local file management application 513a may send an indication to the storage system 508 to refrain from downloading the first file 104 to the client device 202 (e.g., as described above in connection with the step 126 of the routine 120 (shown in FIG. 1A).

In other scenarios, as illustrated in FIG. 8B, the user 102 may provide (820) an input to the local file management application 513a (e.g., in response to the selection of the user interface element 111b shown in FIG. 1B) indicating that the first file 104 is to be downloaded from the file sharing system 504 in spite of the detected duplicate file (or portion thereof) in the local storage 108 of the client device 202.

In response to the local file management application 513a receiving (820) such an input indicating that the download process is to continue, the local file management application 513a may send (822) a request to the storage system 508 to continue with the download of the first file 104.

In response to receiving (822) the request to continue with the download from the local file management application 513a, the storage system 508 may use the access token (received per the step 810 shown in FIG. 8A) to retrieve the first file 104 from the file storage 512, and may send (824) the first file 104 to the local file management application 513a. The local file management application 513a may then cause (826) the first file 104 to be stored on the client device 202, e.g., within the local storage 108 shown in FIGS. 1A and 1B.

FIG. 8C illustrates a second circumstance in which the local file management application 513a determines (per the comparison at the step 814) that no duplicate and/or similar files are present on the client device 202.

As shown in FIG. 8C, the local file management application 513a may determine (828) that no duplicate and/or similar files are stored at the client device 202. In response to making such a determination, the local file management application 513a may send (830) a request to the storage system 508 to continue with the download of the first file 104.

In response to receiving (830) the request to continue with the download from the local file management application 513a, the storage system 508 may use the access token (received per the step 810 shown in FIG. 8A) to retrieve the first file 104 from the file storage 512, and may send (832) the first file 104 to the local file management application 513a. The local file management application 513a may then cause (834) the first file 104 to be stored on the client device 202, e.g., within the local storage 108 shown in FIGS. 1A and 1B.

G. Example Implementations of Methods, Systems, and Computer-Readable Media in Accordance with the Present Disclosure

The following paragraphs (M1) through (M17) describe examples of methods that may be implemented in accordance with the present disclosure.

(M1) A method may be performed that involves receiving, by a computing system, a first request to download a first file to a client device; sending, by the computing system and based at least in part on the first request, a first digest of the first file to the client device to enable the client device to compare the first digest with at least a second digest of a second file stored locally at the client device; and receiving, by the computing system after sending the first digest to the client device, a second request to refrain from downloading the first file to the client device.

(M2) A method may be performed as described in paragraph (M1), wherein the computing system may comprise a first server configured to send the first file to an application executing under control of the client device in response to receipt of an access token corresponding to the first file; and a second server configured to send the access token to the application based at least in part on the first request.

(M3) A method may be performed as described in paragraph (M2), wherein sending the first digest to the client device may further involve sending, from the second server to the client device, the first digest.

(M4) A method may be performed as described in paragraph (M2) or paragraph (M3), and may further involve sending, from the first server to the second server and based at least in part on the first request, the first digest.

(M5) A method may be performed as described in any of paragraphs (M2) through (M4), and may further involve sending, from the first server to the second server and based at least in part on the first request, the access token.

(M6) A method may be performed as described in paragraph (M1), wherein the computing system may comprise at least a first server configured to send the first file to an application executing under control of the client device in response to receipt of an access token corresponding to the first file; and receiving the first request may further involve receiving, by the first server, the access token.

(M7) A method may be performed as described in paragraph (M6), wherein sending the first digest to the client device may further involve sending, from the first server to the client device, the first digest.

(M8) A method may be performed as described in paragraph (M6) or paragraph (M7), and may further involve, prior to receiving the first request, receiving, by a second server of the computing system and from a requesting device, a third request to enable access to the first file; sending, from the first server to the second server and based at least in part on the third request, the access token; and sending, from the second server to the requesting device, the access token.

(M9) A method may be performed as described in paragraph (M8), wherein the client device may be the requesting device.

(M10) A method may be performed as described in paragraph (M8) or paragraph (M9), and may further involve receiving, by the client device and from the requesting device, the access token.

(M11) A method may be performed that involves determining, by a client device, that downloading of a first file from a computing system to the client device has been requested; receiving, by the client device and from the computing system, a first digest of the first file; determining, by the client device, that the first digest matches at least a second digest of a second file stored locally at the client device; and outputting, by the client device and based at least in part on the first digest matching the second digest, an indication that at least a portion of the first file is stored locally at the client device.

(M12) A method may be performed as described in paragraph (M11), and may further involve sending, from an application executing under control of the client device to the computing system and prior to receiving the first digest, a request to download the first file.

(M13) A method may be performed as described in paragraph (M11) or paragraph (M12), and may further involve outputting, by the client device, a prompt to provide an input indicating whether the first file is to be downloaded in view of the indication that the portion of the first file is stored locally at the client device.

(M14) A method may be performed as described in paragraph (M13), and may further involve determining that the input indicates the first file is not to be downloaded; and sending, based at least in part the input, an indication to the computing system to refrain from downloading the first file from the computing system to the client device.

(M15) A method may be performed as described in paragraph (M13), and may further involve determining that the input indicates the first file is to be downloaded; and sending, based at least in part the input, an indication to proceed with downloading the first file from the computing system to the client device.

(M16) A method may be performed as described in any of paragraphs (M11) through (M15), and may further involve receiving, by an application executing under control of the client device and from the computing system, a token for the first file to enable secure transfer of the first file from the computing system to the client device; and sending, from the application to the computing system, the token.

(M17) A method may be performed as described in any of paragraphs (M11) through (M15), and may further involve sending, by the client device to the computing system and prior to receiving the first digest, a request to download the first file, wherein the request includes a token for the first file to enable secure transfer of the first file from the computing system to the client device.

The following paragraphs (S1) through (S17) describe examples of systems and devices that may be implemented in accordance with the present disclosure.

(S1) A system may comprise at least one processor, and at least one computer-readable medium encoded with instructions which, when executed by the at least one processor, cause the system to receive a first request to download a first file to a client device, to send, based at least in part on the first request, a first digest of the first file to the client device to enable the client device to compare the first digest with at least a second digest of a second file stored locally at the client device, and to receive, after sending the first digest to the client device, a second request to refrain from downloading the first file to the client device.

(S2) A system may be configured as described in paragraph (S1), wherein the system may comprise a first server configured to send the first file to an application executing under control of the client device in response to receipt of an access token corresponding to the first file; and a second server configured to send the access token to the application based at least in part on the first request.

(S3) A system may be configured as described in paragraph (S2), wherein the at least one computer-readable medium may be further encoded with additional instructions which, when executed by the at least one processor, further cause the system to send the first digest to the client device at least in part by sending, from the second server to the client device, the first digest.

(S4) A system may be configured as described in paragraph (S2) or paragraph (S3), wherein the at least one computer-readable medium may be further encoded with additional instructions which, when executed by the at least one processor, further cause the system to send, from the first server to the second server and based at least in part on the first request, the first digest.

(S5) A system may be configured as described in any of paragraphs (S2) through (S4), wherein the at least one computer-readable medium may be further encoded with additional instructions which, when executed by the at least one processor, further cause the system to send, from the first server to the second server and based at least in part on the first request, the access token.

(S6) A system may be configured as described in paragraph (S1), wherein the system may comprise at least a first server configured to send the first file to an application executing under control of the client device in response to receipt of an access token corresponding to the first file, and the at least one computer-readable medium may be further encoded with additional instructions which, when executed by the at least one processor, further cause the system to receive the first request at least in part by receiving, by the first server, the access token.

(S7) A system may be configured as described in paragraph (S6), wherein the at least one computer-readable medium may be further encoded with additional instructions which, when executed by the at least one processor, further cause the system to send the first digest to the client device at least in part by sending, from the first server to the client device, the first digest.

(S8) A system may be configured as described in paragraph (S6) or paragraph (S7), wherein the at least one computer-readable medium may be further encoded with additional instructions which, when executed by the at least one processor, further cause the system to, prior to receiving the first request, receive, by a second server of the computing system and from a requesting device, a third request to enable access to the first file, to send, from the first server to the second server and based at least in part on the third request, the access token, and to send, from the second server to the requesting device, the access token.

(S9) A system may be configured as described in paragraph (S8), wherein the client device may be the requesting device.

(S10) A system may be configured as described in paragraph (S8) or paragraph (S9), wherein the at least one computer-readable medium may be further encoded with additional instructions which, when executed by the at least one processor, further cause the system to receive, by the client device and from the requesting device, the access token.

(S1) A system may comprise at least one processor, and at least one computer-readable medium encoded with instructions which, when executed by the at least one processor, cause the system to determine, by a client device, that downloading of a first file from a computing system to the client device has been requested, to receive, by the client device and from the computing system, a first digest of the first file, to determine, by the client device, that the first digest matches at least a second digest of a second file stored locally at the client device, and to output, by the client device and based at least in part on the first digest matching the second digest, an indication that at least a portion of the first file is stored locally at the client device.

(S12) A system may be configured as described in paragraph (S11), wherein the at least one computer-readable medium may be further encoded with additional instructions which, when executed by the at least one processor, further cause the system to send, from an application executing under control of the client device to the computing system and prior to receiving the first digest, a request to download the first file.

(S13) A system may be configured as described in paragraph (S11) or paragraph (S12), wherein the at least one computer-readable medium may be further encoded with additional instructions which, when executed by the at least one processor, further cause the system to output, by the client device, a prompt to provide an input indicating whether the first file is to be downloaded in view of the indication that the portion of the first file is stored locally at the client device.

(S14) A system may be configured as described in paragraph (S13), wherein the at least one computer-readable medium may be further encoded with additional instructions which, when executed by the at least one processor, further cause the system to determine that the input indicates the first file is not to be downloaded, and to send, based at least in part the input, an indication to the computing system to refrain from downloading the first file from the computing system to the client device.

(S15) A system may be configured as described in paragraph (S13), wherein the at least one computer-readable medium may be further encoded with additional instructions which, when executed by the at least one processor, further cause the system to determine that the input indicates the first file is to be downloaded, and to send, based at least in part the input, an indication to proceed with downloading the first file from the computing system to the client device.

(S16) A system may be configured as described in any of paragraphs (S11) through (S15), wherein the at least one computer-readable medium may be further encoded with additional instructions which, when executed by the at least one processor, further cause the system to receive, by an application executing under control of the client device and from the computing system, a token for the first file to enable secure transfer of the first file from the computing system to the client device, and to send, from the application to the computing system, the token.

(S17) A system may be configured as described in any of paragraphs (S11) through (S15), wherein the at least one computer-readable medium may be further encoded with additional instructions which, when executed by the at least one processor, further cause the system to send, by the client device to the computing system and prior to receiving the first digest, a request to download the first file, wherein the request includes a token for the first file to enable secure transfer of the first file from the computing system to the client device.

The following paragraphs (CRM1) through (CRM17) describe examples of systems and devices that may be implemented in accordance with the present disclosure.

(CRM1) At least one non-transitory computer-readable medium may be encoded with instructions which, when executed by the at least one processor included in a system, cause the system to receive a first request to download a first file to a client device, to send, based at least in part on the first request, a first digest of the first file to the client device to enable the client device to compare the first digest with at least a second digest of a second file stored locally at the client device, and to receive, after sending the first digest to the client device, a second request to refrain from downloading the first file to the client device.

(CRM2) At least one non-transitory computer-readable medium may be configured as described in paragraph (CRM1), wherein the system may comprise a first server configured to send the first file to an application executing under control of the client device in response to receipt of an access token corresponding to the first file; and a second server configured to send the access token to the application based at least in part on the first request.

(CRM3) At least one non-transitory computer-readable medium may be configured as described in paragraph (CRM2), and may be further encoded with additional instructions which, when executed by the at least one processor, further cause the system to send the first digest to the client device at least in part by sending, from the second server to the client device, the first digest.

(CRM4) At least one non-transitory computer-readable medium may be configured as described in paragraph (CRM2) or paragraph (CRM3), and may be further encoded with additional instructions which, when executed by the at least one processor, further cause the system to send, from the first server to the second server and based at least in part on the first request, the first digest.

(CRM5) At least one non-transitory computer-readable medium may be configured as described in any of paragraphs (CRM2) through (CRM4), and may be further encoded with additional instructions which, when executed by the at least one processor, further cause the system to send, from the first server to the second server and based at least in part on the first request, the access token.

(CRM6) At least one non-transitory computer-readable medium may be configured as described in paragraph (CRM1), wherein the system may comprise at least a first server configured to send the first file to an application executing under control of the client device in response to receipt of an access token corresponding to the first file, and the at least one computer-readable medium may be further encoded with additional instructions which, when executed by the at least one processor, further cause the system to receive the first request at least in part by receiving, by the first server, the access token.

(CRM7) At least one non-transitory computer-readable medium may be configured as described in paragraph (CRM6), and may be further encoded with additional instructions which, when executed by the at least one processor, further cause the system to send the first digest to the client device at least in part by sending, from the first server to the client device, the first digest.

(CRM8) At least one non-transitory computer-readable medium may be configured as described in paragraph (CRM6) or paragraph (CRM7), and may be further encoded with additional instructions which, when executed by the at least one processor, further cause the system to, prior to receiving the first request, receive, by a second server of the computing system and from a requesting device, a third request to enable access to the first file, to send, from the first server to the second server and based at least in part on the third request, the access token, and to send, from the second server to the requesting device, the access token.

(CRM9) At least one non-transitory computer-readable medium may be configured as described in paragraph (CRM8), wherein the client device may be the requesting device.

(CRM10) At least one non-transitory computer-readable medium may be configured as described in paragraph (CRM8) or paragraph (CRM9), and may be further encoded with additional instructions which, when executed by the at least one processor, further cause the system to receive, by the client device and from the requesting device, the access token.

(CRM11) At least one non-transitory computer-readable medium may be encoded with instructions which, when executed by the at least one processor included in a system, cause the system to determine, by a client device, that downloading of a first file from a computing system to the client device has been requested, to receive, by the client device and from the computing system, a first digest of the first file, to determine, by the client device, that the first digest matches at least a second digest of a second file stored locally at the client device, and to output, by the client device and based at least in part on the first digest matching the second digest, an indication that at least a portion of the first file is stored locally at the client device.

(CRM12) At least one non-transitory computer-readable medium may be configured as described in paragraph (CRM11), and may be further encoded with additional instructions which, when executed by the at least one processor, further cause the system to send, from an application executing under control of the client device to the computing system and prior to receiving the first digest, a request to download the first file.

(CRM13) At least one non-transitory computer-readable medium may be configured as described in paragraph (CRM11) or paragraph (CRM12), and may be further encoded with additional instructions which, when executed by the at least one processor, further cause the system to output, by the client device, a prompt to provide an input indicating whether the first file is to be downloaded in view of the indication that the portion of the first file is stored locally at the client device.

(CRM14) At least one non-transitory computer-readable medium may be configured as described in paragraph (CRM13), and may be further encoded with additional instructions which, when executed by the at least one processor, further cause the system to determine that the input indicates the first file is not to be downloaded, and to send, based at least in part the input, an indication to the computing system to refrain from downloading the first file from the computing system to the client device.

(CRM15) At least one non-transitory computer-readable medium may be configured as described in paragraph (CRM13), and may be further encoded with additional instructions which, when executed by the at least one processor, further cause the system to determine that the input indicates the first file is to be downloaded, and to send, based at least in part the input, an indication to proceed with downloading the first file from the computing system to the client device.

(CRM16) At least one non-transitory computer-readable medium may be configured as described in any of paragraphs (CRM11) through (CRM15), and may be further encoded with additional instructions which, when executed by the at least one processor, further cause the system to receive, by an application executing under control of the client device and from the computing system, a token for the first file to enable secure transfer of the first file from the computing system to the client device, and to send, from the application to the computing system, the token.

(CRM17) At least one non-transitory computer-readable medium may be configured as described in any of paragraphs (CRM11) through (CRM15), and may be further encoded with additional instructions which, when executed by the at least one processor, further cause the system to send, by the client device to the computing system and prior to receiving the first digest, a request to download the first file, wherein the request includes a token for the first file to enable secure transfer of the first file from the computing system to the client device.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a computing system, a first request to download a first file to a client device;
determining that a size of the first file exceeds a threshold;
sending, by the computing system and based at least in part on the first request and the size of the first file exceeding the threshold, a first digest of the first file to the client device to enable the client device to compare the first digest with at least a second digest of a second file stored locally at the client device; and
receiving, by the computing system after sending the first digest to the client device, a second request to refrain from downloading the first file to the client device.

2. The method of claim 1, wherein the computing system comprises:
a first server configured to send the first file to an application executing under control of the client device in response to receipt of an access token corresponding to the first file; and
a second server configured to send the access token to the application based at least in part on the first request.

3. The method of claim 2, wherein sending the first digest to the client device further comprises:
sending, from the second server to the client device, the first digest.

4. The method of claim 3, further comprising:
sending, from the first server to the second server and based at least in part on the first request, the first digest.

5. The method of claim 4, further comprising:
sending, from the first server to the second server and based at least in part on the first request, the access token.

6. The method of claim 1, wherein:
the computing system comprises at least a first server configured to send the first file to an application executing under control of the client device in response to receipt of an access token corresponding to the first file; and
receiving the first request further comprises receiving, by the first server, the access token.

7. The method of claim 6, wherein sending the first digest to the client device further comprises:
sending, from the first server to the client device, the first digest.

8. The method of claim 7, further comprising:
prior to receiving the first request, receiving, by a second server of the computing system and from a requesting device, a third request to enable access to the first file;
sending, from the first server to the second server and based at least in part on the third request, the access token; and
sending, from the second server to the requesting device, the access token.

9. The method of claim 8, wherein the client device is the requesting device.

10. The method of claims 8, further comprising:
receiving, by the client device and from the requesting device, the access token.

11. A method, comprising:
determining, by a client device, that downloading of a first file from a computing system to the client device has been requested;
receiving, by the client device and from the computing system, a first plurality of digests corresponding to respective segments of the first file;
determining, by the client device, a degree of similarity between the first file and a second file stored locally at the client device at least in part by comparing the first plurality of digests with a second plurality of digests corresponding to respective portions of the second file; and
outputting, by the client device and based at least in part on the degree of similarity, an indication that at least a portion of the first file is stored locally at the client device.

12. The method of claim 11, further comprising:
sending, from an application executing under control of the client device to the computing system and prior to receiving the first plurality of digests, a request to download the first file.

13. The method of claim 11, further comprising:
outputting, by the client device, a prompt to provide an input indicating whether the first file is to be downloaded in view of the indication that the portion of the first file is stored locally at the client device.

14. The method of claim 13, further comprising:
determining that the input indicates the first file is not to be downloaded; and
sending, based at least in part the input, an indication to the computing system to refrain from downloading the first file from the computing system to the client device.

15. The method of claim 13, further comprising:
determining that the input indicates the first file is to be downloaded; and
sending, based at least in part the input, an indication to proceed with downloading the first file from the computing system to the client device.

16. The method of claim 11, further comprising:
receiving, by an application executing under control of the client device and from the computing system, a token for the first file to enable secure transfer of the first file from the computing system to the client device; and
sending, from the application to the computing system, the token.

17. The method of claim 11, further comprising:
sending, by the client device to the computing system and prior to receiving the first plurality of digests, a request to download the first file, wherein the request includes a token for the first file to enable secure transfer of the first file from the computing system to the client device.

18. A system, comprising:
at least one processor; and
at least one computer-readable medium encoded with instructions which, when executed by the at least one processor, cause the system to:
receive a first request to download a first file to a client device;
determine that a size of the first file exceeds a threshold;
send, based at least in part on the first request and the size of the first file exceeding the threshold, a first digest of the first file to the client device to enable the client device to compare the first digest with at least a second digest of a second file stored locally at the client device; and
receive, after sending the first digest to the client device, a second request to refrain from downloading the first file to the client device.

19. The system of claim 18, further comprising:
a first server configured to send the first file to an application executing under control of the client device in response to receipt of an access token corresponding to the first file; and
a second server configured to send the access token to the application based at least in part on the first request.

20. The system of claim 19, wherein the at least one computer-readable medium is further encoded with additional instructions which, when executed by the at least one processor, further cause the system to:
send, from the second server to the client device, the first digest.
